(19) United States
(12) Patent Application Publication
(10) Pub. No.: US 2024/0159562 A1
(43) Pub. Date: May 16, 2024

(54) MAP DATA DELIVERY SYSTEM

(71) Applicant: DENSO CORPORATION, Kariya-city (JP)

(72) Inventor: Shinya ABE, Kariya-city (JP)

(21) Appl. No.: 18/423,099

(22) Filed: Jan. 25, 2024

Related U.S. Application Data
(63) Continuation of application No. PCT/JP2022/028353, filed on Jul. 21, 2022.

(30) Foreign Application Priority Data
Jul. 27, 2021 (JP) 2021-122452

(51) Int. Cl. G01C 21/00; B60W 60/00

(52) U.S. Cl. CPC G01C 21/387; B60W 60/001; G01C 21/3841; G01C 21/3896; B60W 2556/40; B60W 2556/45

(57) ABSTRACT

A map data delivery system in which map data is delivered from a map data delivery apparatus to an onboard apparatus is provided. The map data delivery system collates target information of a target object included in the map data and target information of a target object acquired by an autonomous sensor mounted in a vehicle on a per-target basis. The map data delivery system determines quality of the map data based on the collation result regarding the target information. The map data delivery system determines validity of the map data based on the determination result regarding the quality of the map data. The map data delivery system permits validity of the map data in response to the map data being determined to be valid.

### CROSS-REFERENCE TO RELATED APPLICATION

The present application is a continuation application of International Application No. PCT/JP2022/028353, filed on Jul. 21, 2022, which claims priority to Japanese Patent Application No. 2021-122452, filed on Jul. 27, 2021. The contents of these applications are incorporated herein by reference in their entirety.

### BACKGROUND

The present disclosure relates to a map data delivery system. Map data delivery apparatuses have been provided with a configuration in which map data is generated using probe data transmitted from an onboard apparatus.

### SUMMARY

One aspect of the present disclosure provides a map data delivery system in which map data is delivered from a map data delivery apparatus to an onboard apparatus. The map data delivery system collates target information of a target object included in map data and target information of a target object acquired by an autonomous sensor mounted in a vehicle on a per-target basis. The map data delivery system determines quality of the map data based on the collation result regarding the target information. The map data delivery system determines whether the map data is valid based on the determination result regarding the quality of the map data. The map data delivery system permits validity (validation) of the map data in response to the map data being determined to be valid.

### BRIEF DESCRIPTION OF THE DRAWINGS

In the accompanying drawings:

FIG. 1 is a functional block diagram illustrating an overall configuration of a map data delivery system according to a first embodiment;

FIG. 2 is a diagram illustrating aspects of provisional delivery and actual delivery of map data;

FIG. 3 is a diagram illustrating conversion from an absolute coordinate system to an own-vehicle position coordinate system;

FIG. 4 is a diagram illustrating conversion of numeric values from the absolute coordinate system to the own-vehicle position coordinate system;

FIG. 5 is a diagram illustrating an aspect of collation of data points of boundary lines;

FIG. 6 is a diagram illustrating an aspect of collation of data points of a sign;

FIG. 7 is a flowchart illustrating a collation process for provisional delivery performed by an onboard apparatus;

FIG. 8 is a flowchart illustrating a deliverability determination process for provisional delivery performed by a server;

FIG. 9 is a flowchart illustrating a collation process for actual delivery performed by the onboard apparatus;

FIG. 10 is a flowchart illustrating a deliverability determination process for actual delivery performed by the server;

FIG. 11 is a diagram illustrating usability per lane;

FIG. 12 is a diagram illustrating usability per lane;

FIG. 13 is a flowchart illustrating the collation process for actual delivery performed by the onboard apparatus;

FIG. 14 is a diagram illustrating aspects of provisional delivery and actual delivery of map data according to a second embodiment;

FIG. 15 is a flowchart illustrating a collation process for an anomalous point detection phase performed by the onboard apparatus;

FIG. 16 is a flowchart illustrating a phase transition determination process performed by the server;

FIG. 17 is a flowchart illustrating a collation process for an anomalous point inspection phase performed by the onboard apparatus;

FIG. 18 is a flowchart illustrating a collation process for an anomalous point inspection phase performed by the server;

FIG. 19 is a functional block diagram of an overall configuration of a map data delivery system according to a third embodiment;

FIG. 20 is a flowchart illustrating a collation process for provisional use performed by the onboard apparatus;

FIG. 21 is a flowchart illustrating a usability determination process for provisional use performed by the server;

FIG. 22 is a flowchart illustrating a collation process for actual use performed by the onboard apparatus; and

FIG. 23 is a flowchart illustrating a usability determination process for actual use performed by the server.

### DESCRIPTION OF THE EMBODIMENTS

Map data delivery apparatuses have been provided with a configuration in which map data is generated using probe data transmitted from an onboard apparatus. As a method for performing quality assurance of map data, for example, JP 2020-038634 A discloses a method in which first route information generated based on provisional map data and second route information generated based on a traveling trajectory of a vehicle are collated, differences between the first route information and the second route information are calculated, and the provisional map data is updated with actual map data when the calculated amount of differences is less than a predetermined value.

In the method in JP 2020-038634 A, quality assurance of map data can only be performed on a per-route basis. Quality assurance of map data on, for example, a per-feature basis or a per-lane basis cannot be performed.

It is thus desired to enable quality assurance of map data to be performed on, for example, a per-feature basis or a per-lane basis, and appropriately perform quality assurance of map data.

An exemplary embodiment of the present disclosure provides a map data delivery system in which map data is delivered from a map data delivery apparatus to an onboard apparatus. The map data delivery system includes: a target information collation unit that collates target information of a target object included in the map data and target information of a target object acquired by an autonomous sensor mounted in a vehicle on a per-target basis; a quality determination unit that determines quality of the map data based on the collation result regarding the target information; a determination result transmission unit that transmits a determination result regarding the quality of the map data to the map data delivery apparatus; a validity determination unit that determines whether the map data is valid based on the determination result regarding the quality of the map data; and a validity control unit that permits validity (validation) of the map data in response to the map data being determined to be valid. The determination result transmission unit does not transmit the determination results for good quality of the map data to the map data delivery apparatus and transmits only the determination results for poor quality to the map data delivery apparatus until a predetermined condition is determined to be established, and transmits the determination result regarding the quality of the map data to the map data delivery apparatus after the predetermined condition is determined to be established.

The quality of the map data is determined based on the collation result collating the target information of a target object included in the map data and the target information of a target object acquired by the autonomous sensor mounted in the vehicle on a per-target basis. It is determined whether the map data is valid based on the determination result regarding the quality of the map data. In response to the map data being determined to be valid, validity of the map data is permitted. Unlike that in the past in which route information is collated, quality assurance of the map data can be performed on, for example, a per-feature basis or a per-lane basis by features, lanes, and the like included in the map data being set as the target object, and quality assurance of the map data can be appropriately performed.

The above-described exemplary embodiment of the present disclosure will be further clarified through the detailed description below, with reference to the accompanying drawings.

A plurality of embodiments will hereinafter be described with reference to the drawings. Descriptions of sections according to subsequent embodiments that are redundant with those according to preceding embodiments are omitted.

### First Embodiment

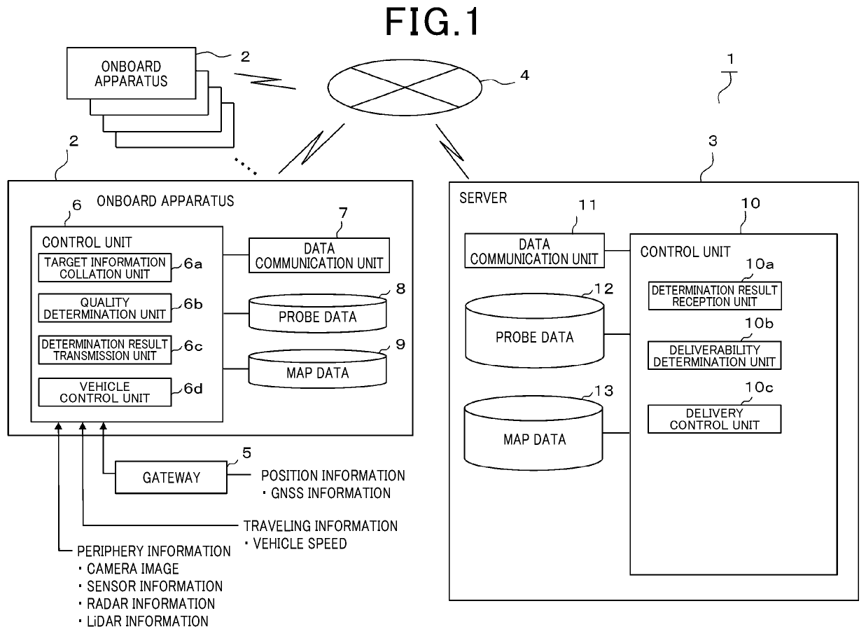

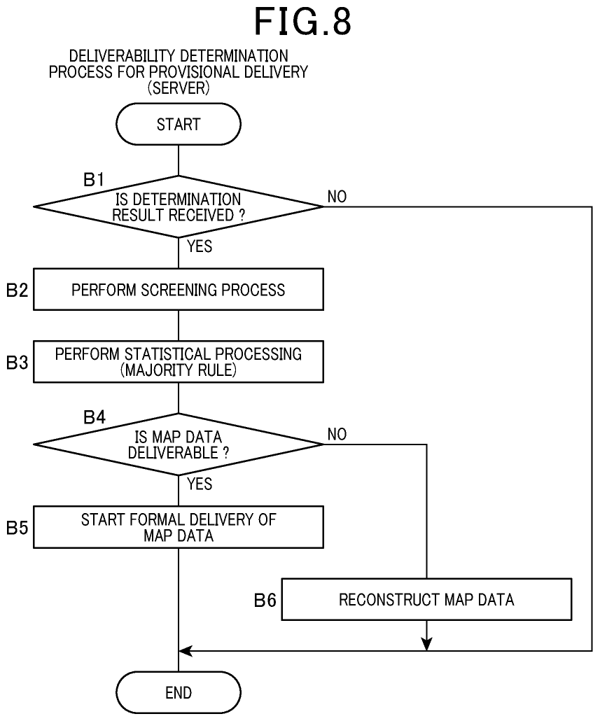

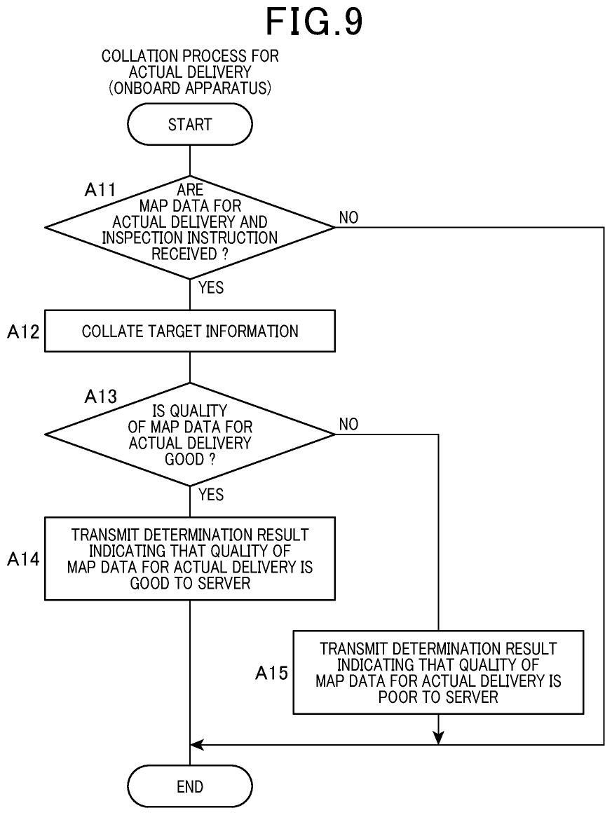

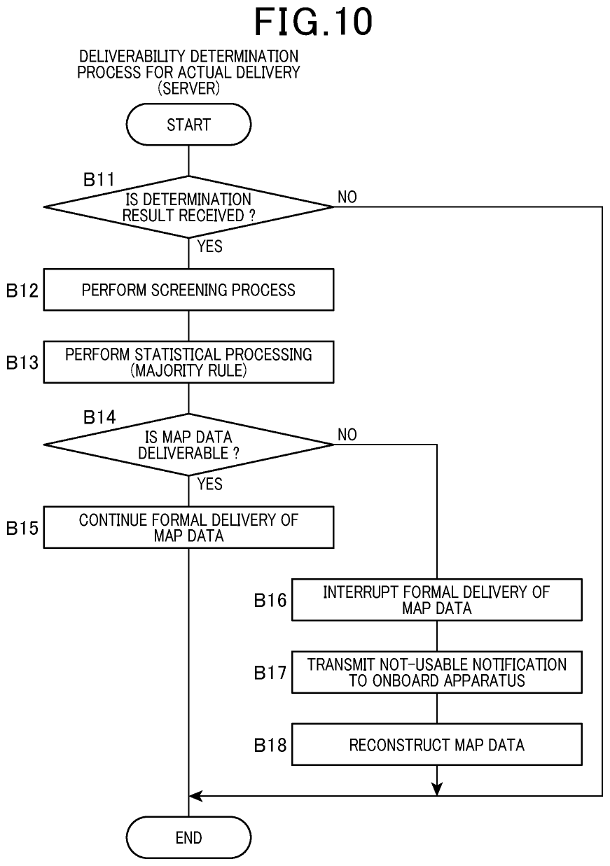

A first embodiment will be described below with reference to FIG. 1 to FIG. 13.

As shown in FIG. 1, a map data delivery system 1 is configured to enable data communication between an onboard apparatus 2 that is mounted in a vehicle and a server 3 that is disposed on a network side through a communication network 4 including, for example, the internet. The vehicle in which the onboard apparatus 2 is mounted may be a vehicle that is provided with an automated driving function or a vehicle that is not provided with an automated driving function. The vehicle that is provided with an automated driving function travels while successively switching between automated driving and manual driving.

The onboard apparatus 2 and the server 3 have a plural-to-one relationship. The server 3 is capable of performing data communication with a plurality of onboard apparatuses 2. The server 3 corresponds to a map data delivery apparatus. According to the first embodiment, as map data validity, deliverability of map data from the server 3 to the onboard apparatus 2 is determined.

The onboard apparatus 2 inputs periphery information related to vehicle periphery, traveling information related to vehicle travel, and position information related to vehicle position from various sensors and various electronic control units (ECUs) mounted in the vehicle. As the periphery information, the onboard apparatus 2 inputs camera images in a vehicle advancing direction captured by an onboard camera, sensor information in which the vehicle periphery is detected by a sensor such as a millimeter-wave sensor, radar information in which the vehicle periphery is detected by a radar, LiDAR (Light Detection and Ranging, Laser Imaging Detection and Ranging) information in which the vehicle periphery is detected by a LiDAR, and the like.

The onboard camera, the sensor, the radar, and the LiDAR are autonomous sensors. The periphery information is information acquired by the autonomous sensor. The camera image includes traffic lights, signs, and signboards set on roads, boundary lines, stop lines at intersections, pedestrian crossings, and diamond-shaped markings within intersections painted on road surfaces, and the like. The onboard apparatus 2 may input at least one of the camera image, the sensor information, the radar information, and the LiDAR information as the periphery information.

As the traveling information, the onboard apparatus 2 inputs vehicle speed information detected by a vehicle sensor. As the position information, the onboard apparatus 2 inputs Global Navigation Satellite System (GNSS) information obtained by positioning by a GNSS receiver through a gateway 5 that serves as a relay apparatus. The GNSS is a general term for pan-global positioning and navigation satellite systems. Various systems such as Global Positioning System (GPS), Global Navigation Satellite System (GLONASS), Galileo, BeiDou, Indian Regional Navigational Satellite System (IRNSS) have been implemented.

The onboard apparatus 2 includes a control unit 6, a data communication unit 7, a probe data storage unit 8, and a map data storage unit 9. The control unit 6 is configured by a microcomputer that has a central processing unit (CPU), a read-only memory (ROM), a random-access memory (RAM), and an input/output (I/O). The microcomputer controls overall operations of the onboard apparatus 2 by running a computer program stored in a non-transitory computer-readable (tangible) storage medium and performing processes corresponding to the computer program. The microcomputer is synonymous with a processor.

In the onboard apparatus 2, the non-transitory computer-readable (tangible) storage medium may share hardware with other computer resources. The probe data storage unit 8 and the map data storage unit 9 may be configured by one or a plurality of non-transitory, tangible recording media independently provided for the respective corresponding data. The probe data storage unit 8 and the map data storage unit 9 may be configured by a shared non-transitory computer-readable (tangible) storage medium. The probe data storage unit 8 and the map data storage unit 9 may correspond to a single storage medium or may correspond to a portion of a recording area in one or a plurality of recording media. A storage apparatus may be configured to include at least one of the probe data storage unit 8 and the map data storage unit 9. The storage apparatus may further include a circuit for reading and rewriting data.

The server 3 includes a control unit 10, a data communication unit 11, a probe data storage unit 12, and a map data storage unit 13. The control unit 10 is configured by a microcomputer that has a CPU, a ROM, a RAM, and an I/O. The microcomputer controls overall operations of the server 3 by running a computer program stored in a non-transitory computer-readable (tangible) storage medium and performing processes corresponding to the computer program. In the server 3 as well, the non-transitory computer-readable (tangible) storage medium may share hardware with other computer resources. The probe data storage unit 12 and the map data storage unit 13 may be mainly configured by non-transitory computer-readable (tangible) storage media independently provided for the respective corresponding data.

In the onboard apparatus 2, when the periphery information, the traveling information, and the position information are inputted, the control unit 6 generates probe data from the various types of inputted information and stores the generated probe data in the probe data storage unit 8. The probe data is data configured to include the periphery information, the traveling information, and the position information, and includes data indicating positions, colors, characteristics, relative positional relationships, and the like of traffic lights, signs, and signboards set on roads, boundary lines, stop lines at intersections, pedestrian crossings, and diamond-shaped markings within intersections painted on road surfaces, and the like. In addition, the probe data also includes data indicating road shape, road characteristics, road width, and the like related to a road on which the vehicle is traveling.

The control unit 6 reads the probe data stored in the probe data storage unit 8 and causes the data communication unit 7 to transmit the read probe data to the server 3 using, for example, a predetermined amount of time elapsing or a traveling distance of the vehicle reaching a predetermined distance as a trigger. Instead of using the above-described amount of time or traveling distance of the vehicle as the trigger, the control unit 6 may use the data communication unit 7 receiving a probe data transmission request from the server 3 as the trigger, if the configuration is such that the server 3 transmits the probe data transmission request to the onboard apparatus 2 at a predetermined cycle.

The control unit 6 may then read the probe data stored in the probe data storage unit 8 and cause the data communication unit 7 to transmit the read probe data to the server 3. In addition, the control unit 6 may cause the data communication unit 7 to transmit to the server 3, at ignition-on, the probe data accumulated during, for example, a trip from a previous ignition-on to ignition-off. Alternatively, the control unit 6 may cause the data communication unit 7 to transmit to the server 3, at ignition-off, the probe data accumulated during, for example, a trip from a current ignition-on to ignition-off.

When making the data communication unit 7 transmit the probe data to the server 3, the control unit 6 may cause the data communication unit 7 to transmit, to the server 3, the probe data on a per-segment basis that is per area determined in advance for map management. Alternatively, the control unit 6 may cause the data communication unit 7 to transmit, to the server 3, the probe data per predetermined area unrelated to the segment.

The map data storage unit 9 stores therein highly accurate map data for actualizing driving assistance. The map data stored in the map data storage unit 9 includes three-dimensional map information, feature information, road attribute value information, and the like.

The three-dimensional map information is information including point groups of feature points of road shapes and structures. The feature information is information related to shapes and positions of traffic lights, signs, signboards, boundary lines, stop lines at intersections, pedestrian crossings, diamond-shaped markings within intersections, and the like. The road attribute value information is information related to traffic lanes in the road and is information related to a number of traffic lanes, presence/absence of right turn-only lanes, and the like.

The map data stored in the map data storage unit 9 is successively updated by map data stored in the map data storage unit 13 of the server 3, described hereafter, being downloaded from the server 3 to the onboard apparatus 2.

In the server 3, the map data storage unit 13 stores therein highly accurate map data for actualizing driving assistance. The map data stored in the map data storage unit 13 is data of a greater volume than the map data stored in the map data storage unit 9 of the onboard apparatus 2 and is data reflecting information on a wide area. The control unit 10 receives the probe data transmitted from the onboard apparatus 2 by the data communication unit 11 and stores the received probe data in the probe data storage unit 12. The control unit reads the probe data stored in the probe data storage unit 12 and successively updates the map data stored in the map data storage unit 13 by successively reflecting the read probe data in the map data. That is, the map data stored in the map data storage unit 13 is integrated map data generated by a plurality of pieces of probe data being successively reflected therein.

In the configuration described above, the onboard apparatus 2 and the server 3 provide the following functions as a configuration for performing quality assurance of the map data. There are a plurality of types (two types according to the present embodiment) of map data stored in the onboard apparatus 2 and the server 3. For example, the map data is differentiated between map data for provisional delivery that is before formal delivery and map data for actual delivery that is after formal delivery, on a per-predetermined area basis. The map data for provisional delivery corresponds to map data for provisional validity. The map data for actual delivery corresponds to map data for actual validity.

This differentiation may be implemented by the storage media or storage areas being separated. Alternatively, this differentiation may be implemented by information indicating the type being incorporated or associated with each piece of map data. The map data for provisional delivery is map data that is not used for vehicle control in the onboard apparatus 2. The map data for actual delivery is map data that is used for vehicle control in the onboard apparatus 2.

According to the present embodiment, the onboard apparatus 2 and the server 3 cooperate to perform quality assurance of the map data for provisional delivery and the map data for actual delivery. The map data for actual delivery corresponds to a first type of map data and the map data for provisional delivery corresponds to a second type of map data.

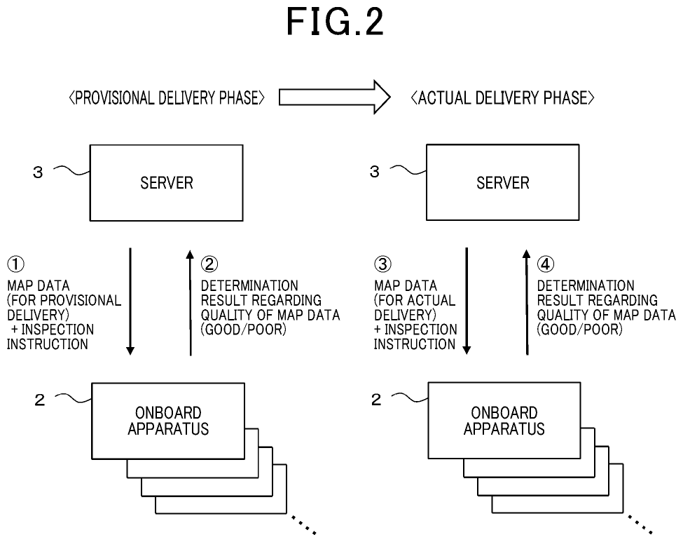

As shown in FIG. 2, as aspects of delivery of map data from the onboard apparatus 2 to the server 3, there are a provisional delivery phase and an actual delivery phase. In the provisional delivery phase, the server 3 generates the map data and processes the generated map data as the map data for provisional delivery. The server 3 then transmits the map data for provisional delivery and an inspection instruction to an plurality of unspecified onboard apparatuses 2.

Upon receiving the map data for provisional delivery and the inspection instruction transmitted from the server 3, the plurality of unspecified onboard apparatuses 2 collate target information on a target object included in the received map data for provisional delivery and target information on a target object acquired by the autonomous sensor mounted in the vehicle on a per-target basis. The plurality of unspecified onboard apparatuses 2 determine quality of the map data for provisional delivery and transmit the determination results regarding the quality of the map data for provisional delivery to the server 3. In this case, the target object is a feature, a lane, a road, a tile referring to a predetermined segment, or the like.

Upon receiving the determination results regarding the quality of the map data for provisional delivery transmitted from the plurality of unspecified onboard apparatuses 2, the server 3 performs statistical analysis of the received determination results and determines deliverability of the map data for provisional delivery. When determined that the map data for actual delivery is deliverable, the server 3 transitions from the provisional delivery phase to the actual delivery phase and processes the map data processed for provisional delivery as the map data for actual delivery.

In the actual delivery phase, the server 3 transmits the map data for actual delivery and the inspection instruction to an plurality of unspecified onboard apparatuses 2. Upon receiving the map data for actual delivery and the inspection instruction, the plurality of unspecified onboard apparatuses 2 collate target information on a target object included in the received map data for actual delivery and target information on a target object acquired by the autonomous sensor mounted in the vehicle on a per-target basis. The plurality of unspecified onboard apparatuses 2 determine quality of the map data for actual delivery and transmit the determination results regarding the quality of the map data for actual delivery to the server 3.

Upon receiving the determination results regarding the quality of the map data for actual delivery transmitted from the plurality of unspecified onboard apparatuses 2, the server 3 performs statistical analysis of the received determination results and determines deliverability of the map data for actual delivery.

The onboard apparatus 2 and the server 3 provide functions described below as a configuration for actualizing the above-described processes. In the onboard apparatus 2, the control unit 6 has a target information collation unit 6a, a quality determination unit 6b, a determination result transmission unit 6c, and a vehicle control unit 6d. The target information collation unit 6a collates the target information on a target object included in the map data and the target information on a target object acquired by the autonomous sensor on a per-target basis.

That is, when the target object is a feature, the target information collation unit 6a collates the feature information on the feature on a per-feature basis. When the target object is a lane, the target information collation unit 6a collates the lane information on the lane on a per-lane basis. When the target object is a road, the target information collation unit 6a collates the road information on the road on a per-road basis. When the target object is a tile, the target information collation unit 6a collates the tile information on the tile on a per-tile basis.

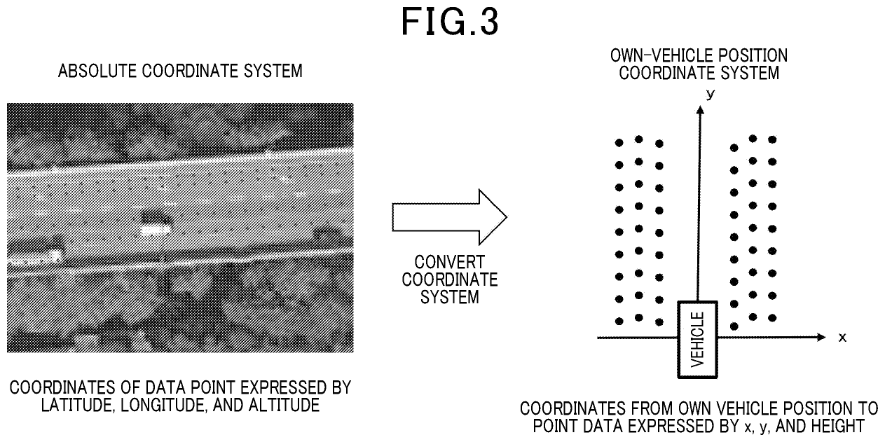

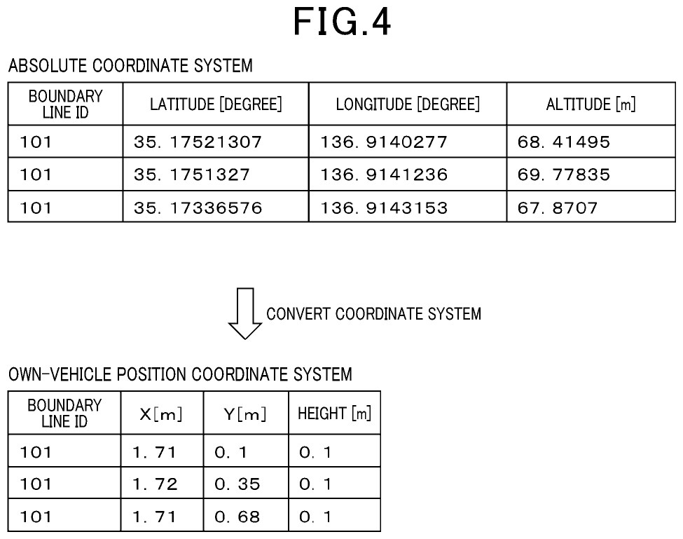

As shown in FIG. 3 and FIG. 4, the target information collation unit 6a converts the map data from an absolute coordinate system to an own-vehicle position coordinate system. The absolute coordinate system is a coordinate system in which coordinates of a data point are expressed by latitude, longitude, and altitude. The own-vehicle position coordinate system is a coordinate system in which coordinates from an own vehicle position to a data point are expressed by x (vehicle width direction), y (vehicle length direction), and height (vehicle height direction). In FIG. 3 and FIG. 4, a boundary line is given as an example of a feature. However, this similarly applies to other features.

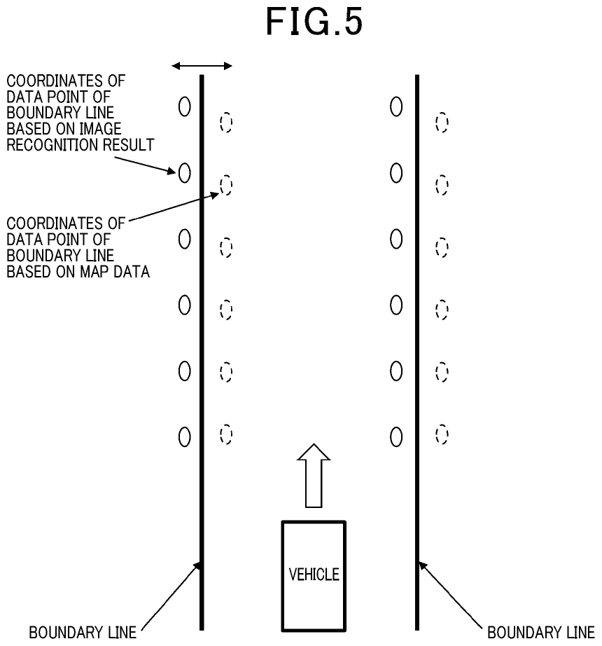

As shown in FIG. 5, for example, when collating the boundary line as the feature, the target information collation unit 6a collates the coordinates of data points of the boundary line indicated in the map data and the coordinates of data points of the boundary line indicated in an image recognition result of a camera image. In this case, the target information collation unit 6a also determines a color and a line type of the boundary line in addition to determining the x coordinate of the boundary line.

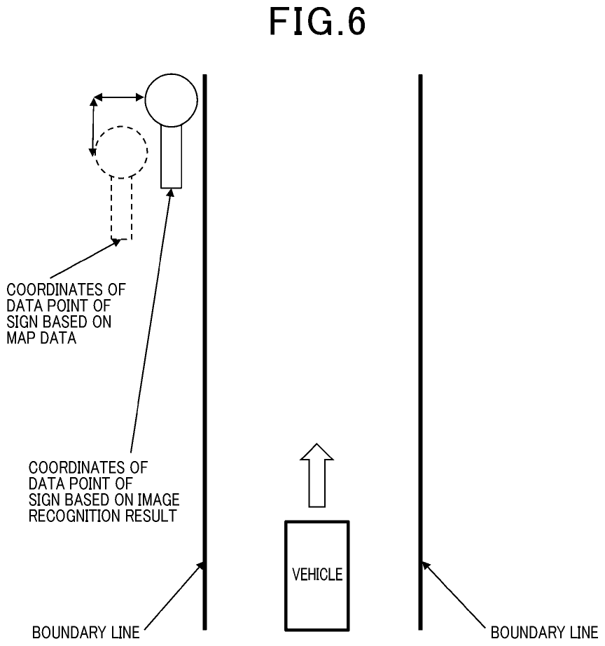

As shown in FIG. 6, for example, when collating a sign as the feature, the target information collation unit 6a collates the coordinates of data points of the sign indicated in the map data and the coordinates of data points of the sign indicated in an image recognition result of a camera image. In this case, the target information collation unit 6a also determines a color and a type of the sign in addition to determining the x coordinate and the y coordinate of the sign.

The quality determination unit 6b determines the quality of the map data based on the collation result of the feature information by the target information collation unit 6a. The quality determination unit 6b determines the quality of the map data on a per-feature basis, a per-lane basis, a per-road basis, a per-tile basis, and the like. That is, the map data of which the quality is to be determined by the quality determination unit 6b is map data on a per-feature basis, a per-lane basis, a per-road basis, a per-tile basis, or the like.

For example, when the feature to be determined is a boundary line and the x coordinate of the boundary line is to be determined, the quality determination unit 6b determines whether an x component of a distance between one predetermined data point in the map data and a regression line of a plurality of data points in the image recognition result close to the predetermined data point, or an average or a dispersion, exceeds a threshold.

The quality determination unit 6b determines that the quality is good when the threshold is not exceeded and determines that the quality is poor when the threshold is exceeded. In addition, the quality determination unit 6b determines whether a difference between a slope of a regression line of a plurality of data points in the map data and a slope of a regression line of a plurality of data points in the image recognition result corresponding to the plurality of data points exceed a threshold. The quality determination unit 6b determines that the quality is good when the threshold is not exceeded and determines that the quality is poor when the threshold is exceeded. When determining the color and the line type of the boundary line, the quality determination unit 6b determines whether the colors and the line types match between a predetermined data point in the map data and a data point in the image recognition result close to the predetermined data point.

For example, when the feature to be determined is a sign, the quality determination unit 6b may determine the x coordinate and the y coordinate of the sign or determine the x coordinate, the y coordinate, and the z coordinate of the sign. When determining the x coordinate and the y coordinate of the sign, the quality determination unit 6b determines whether the x component and the y component of a distance between one predetermined data point in the map data and a data point in the image recognition result close to the predetermined data point respectively exceed thresholds.

The quality determination unit 6b determines that the quality is good when the threshold is not exceeded and determines that the quality is poor when the threshold is exceeded. When determining the x coordinate, the y coordinate, and the z coordinate of the sign, the quality determination unit 6b determines whether the x component, the y component, and the z component of a distance between one predetermined data point in the map data and a data point in the image recognition result close to the predetermined data point respectively exceed thresholds. The quality determination unit 6b determines that the quality is good when the threshold is not exceeded and determines that the quality is poor when the threshold is exceeded.

When determining the color and the type of the sign, the quality determination unit 6b determines whether the colors and the types match between a predetermined data point in the map data and a data point in the image recognition result close to the predetermined data point. When the feature to be determined is a structure that has a plane such as a sign or a signboard, the quality determination unit 6b may determine a normal vector indicating an orientation of the plane. When determining the normal vector, the quality determination unit 6b determines whether the normal vectors match between a predetermined data point in the map data and a data point in the image recognition result close to the predetermined data point. When the feature to be determined is a traffic light, a direction of light is the direction of the normal vector.

The determination result transmission unit 6c causes the data communication unit 7 to transmit, to the server 3, the determination result regarding the quality of the map data from the quality determination unit 6b. In this case, in addition to the determination result regarding the quality of the map data from the quality determination unit 6b, the determination result transmission unit 6c also causes the data communication unit 7 to transmit, to the server 3, information related to the determination target information related to a calculation result calculated during the process of determination, information related to vehicle control, information related to a surrounding environment, and the like.

Furthermore, the determination result transmission unit 6c may cause the data communication unit 7 to transmit, to the server 3, the determination results regarding quality for all features included in the map data. Alternatively, the determination result transmission unit 6c may select the determination result regarding quality to be transmitted from the data communication unit 7 to the server 3 based on an image recognition result. The determination result transmission unit 6c may determine accuracy of image recognition by determining a recognition level of image recognition to be a threshold and select whether to cause the data communication unit 7 to transmit the determination result regarding quality to the server 3.

The determination result transmission unit 7 may not cause the data communication unit 7 to transmit, to the server 3, the determination result regarding quality of a feature of which the recognition level is less than the threshold and may cause the data communication unit 7 to transmit, to the server 3, the determination result regarding quality of a feature of which the recognition level is equal to or greater than the threshold.

Moreover, the determination result regarding quality to be transmitted from the data communication unit 7 to the server 3 may be selected based on detection results from various sensors, an operation state of an onboard apparatus, and the like, in addition to the image recognition result. For example, the detection results of the autonomous sensor tend to decrease during rainfall or snowfall.

Therefore, the determination result transmission unit 6c may not cause the data communication unit 7 to transmit, to the server 3, the determination results regarding quality during operation of windshield wipers or during detection by a rainfall sensor, and cause the data communication unit 7 to transmit, to the server 3, the determination results regarding quality during non-operation of the windshield wipers or during non-detection by the rainfall sensor.

For example, when the x coordinate of the boundary line is determined, the determination result transmission unit 6c causes the data communication unit 7 to transmit the following information to the server 3. As information related to the determination target object, the determination result transmission unit 6c causes the data communication unit 7 to transmit, to the server 3, a version of the map that is used, a mesh (segment) number, a boundary line identifier (ID) of the determination target object, a distance from a boundary line terminal, other indicators allowing identification of the boundary line or a section of the boundary line to be determined, and the like.

As information related to the calculation result calculated in the process of determination, the determination result transmission unit 6c causes the data communication unit 7 to transmit, to the server 3, coordinates of the map data to be inspected in the own-vehicle position coordinate system, coordinates of a recognition point used for determination, a calculated distance, an x component of the distance, an average or dispersion of the x component, a slope of a data point string, a number of map data points and recognition points, and the like. As information related to vehicle control, the determination result transmission unit 6c causes the data communication unit 7 to transmit, to the server 3, own-vehicle-position absolute coordinates, a steering wheel angle, an accelerator state, a brake state, an automated driving application state, sensor states, and the like. As information related to the surrounding environment, the determination result transmission unit 6c causes the data communication unit 7 to transmit, to the server 3, presence/absence of a preceding vehicle, presence/absence of a following vehicle, rainfall or snowfall state, and the like.

The vehicle control unit 6d performs vehicle control based on the collation result for each attribute related to a feature to be collated. When the feature is a boundary line, the attributes are color, coordinates, line type, line width, and the like. When the color of the boundary line is positive and the boundary line is yellow, the vehicle control unit 6d issues a warning during turn-signal operation and suppresses steering control for changing lanes and passing and deviating from the lane. When the coordinates of the boundary line are positive, the vehicle control unit 6d uses the map data for simple lane tracing assist (LTA) control and identification of the own vehicle position. For example, the vehicle control unit 6d prevents deviation by decelerating or the like in advance when a curve or a stop line is present ahead outside of sensor recognition, and performs deceleration control or stop control by identifying a traffic light that is far and not easily identified by a sensor, or a traffic light to be obeyed by the own vehicle from a plurality of traffic lights. When the line type is positive, if course change is prohibited or if passing and deviating on the right side is prohibited, the vehicle control unit 6 issues a warning during turn signal operation and suppresses steering control for lane change or passing and deviating from the lane, and if parking or stopping is prohibited, the vehicle control unit 6 issues a warning when parking or stopping.

When the feature is a sign, the attributes are coordinates, type, and the like. When the coordinates of the sign are positive, the vehicle control unit 6d uses the map for simple LTA control and identification of the own vehicle position. When the type is positive, for example, the vehicle control unit 6d performs, in real time or in advance, control to obey the sign such as temporarily stopping or decelerating vehicle speed to a speed limit. That is, the vehicle control unit 6d performs control similarly corresponding to correspondence between a style of the sign, the boundary line, or road paint designated by “Order on Road Signs, Boundary lines, and Road Markings” and instruction details thereof.

In the server 3, the control unit 10 has a determination result reception unit 10a, a deliverability determination unit 10b, and a delivery control unit 10c. The deliverability determination unit 10 corresponds to a validity determination unit. The delivery control unit 10c corresponds to a validity control unit. These units 10a to 10c correspond to a portion of a function performed by a quality assurance program for map data. That is, the control unit performs the functions of the units 10a to 10c by running a portion of the quality assurance program for map data.

The determination result reception unit 10a receives the determination result regarding the quality of the map data transmitted from the onboard apparatus 2. The deliverability determination unit 10b determines deliverability of the map data based on the determination result regarding the quality of the map data transmitted from the onboard apparatus 2. As a method for determining the deliverability of the map data, the deliverability determination unit 10b performs a screening process and statistical processing by majority rule.

As the screening process, the deliverability determination unit 10b uses the information related to the calculation result calculated during the process of determination, the information related to vehicle control, and the information related to the surrounding environment among the determination results received from the onboard apparatus 2 and excludes determination results that are expected to have low correctness. Specifically, the deliverability determination unit 10b excludes the determination result, for example, when information that automated driving control is not appropriately performed is included, when information of failure is included in the sensor state information, or when information that the preceding vehicle is present ahead at a close distance is included. As the statistical processing by majority rule, the deliverability determination unit 10b calculates which of the determination results indicating good quality and the determination results indicating poor quality is greater in number if there is a plurality of determination results after the above-described screening is completed, and uses the determination results determined to be greater in number.

During provisional delivery of map data, if the deliverability determination unit 10b determines that the map data for provisional delivery is deliverable, the delivery control unit 10c permits delivery of the map data from the server 3 to the onboard apparatus 2 and starts the formal delivery of map data from the server 3 to the onboard apparatus 2. That is, the delivery control unit 10c provides the vehicle with map data that can be used for vehicle control as a result of the formal delivery of map data from the server 3 to the onboard apparatus 2 being started. Meanwhile, if the deliverability determination unit 10b determines that the map data for provisional delivery is not deliverable, the delivery control unit 10c reconstructs the map data without starting the formal delivery of map data from the server 3 to the onboard apparatus 2.

During actual delivery of map data, if the deliverability determination unit 10b determines that the map data for actual delivery is deliverable, the delivery control unit 10c permits delivery of the map data from the server 3 to the onboard apparatus 2 and continues the formal delivery of map data from the server 3 to the onboard apparatus 2. That is, the delivery control unit 10c continues to provide the vehicle with map data that can be used for vehicle control as a result of the formal delivery of map data from the server 3 to the onboard apparatus 2 being continued. Meanwhile, if the deliverability determination unit 10b determines that the map data for actual delivery is not deliverable, the delivery control unit 10c interrupts, rather than continues, the formal delivery of map data from the server 3 to the onboard apparatus 2, causes the data communication unit 11 to transmit a map data not-usable notification to the onboard apparatus 2, and reconstructs the map data.

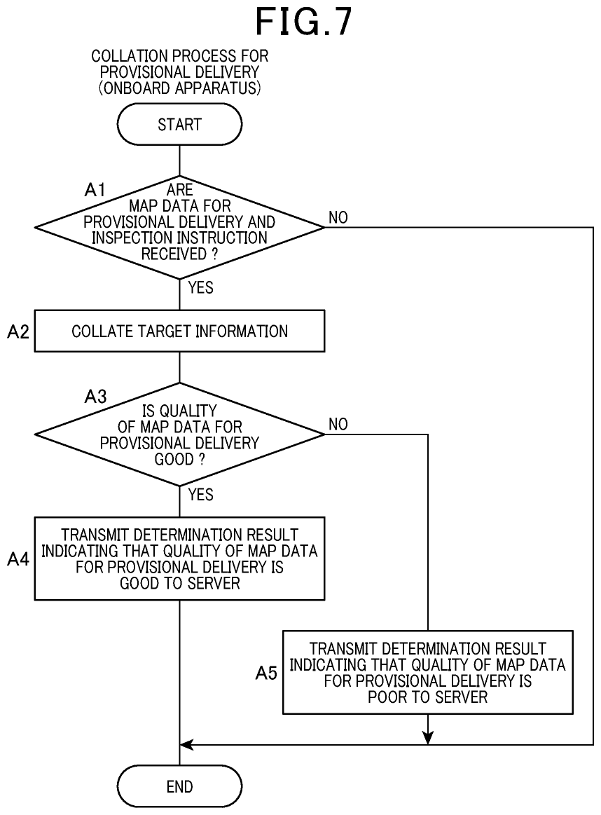

Next, workings of the configuration described above will be described with reference to FIG. 7 to FIG. 11. Processes performed by the onboard apparatus 2 and the server 3 during provisional delivery and actual delivery of map data will be successively described. During provisional delivery of map data, the onboard apparatus 2 performs a collation process for provisional delivery and the server 3 performs a deliverability determination process for provisional delivery. During actual delivery of map data, the onboard apparatus 2 performs a collation process for actual delivery and the server 3 performs a deliverability determination process for actual delivery.

(1-1) Collation Process for Provisional Delivery Performed by the Onboard Apparatus 2

In the onboard apparatus 2, the control unit 6 determines establishment of a starting condition for the collation process for provisional delivery. For example, as the starting condition for the collation process for provisional delivery, the control unit 6 determines whether an update of map data is performed in the onboard apparatus 2 or the server 3 on any of a per-feature basis, a per-lane basis, a per-road basis, a per-tile basis, or the like.

When determined that the update of the map data is performed in the onboard apparatus 2 or the server 3 on any of a per-feature basis, a per-lane basis, a per-road basis, a per-tile basis, or the like, the control unit 6 determines that the starting condition for the collation process for provisional delivery is established and starts the collation process for provisional delivery. When the collation process for provisional delivery is started, the control unit 6 determines reception of the map data for provisional delivery and the inspection instruction transmitted from the server 3 (A1). When determined that the map data for provisional delivery and the inspection instruction transmitted from the server 3 are not received (NO at A1), the control unit 6 ends the collation process for provisional delivery, and waits for a subsequent establishment of the starting condition for the collation process for provisional delivery.

When determined that the map data for provisional delivery and the inspection instruction transmitted from the server 3 are received by the data communication unit 7 (YES at A1), the control unit 6 collates the target information of a target object included in the received map data for provisional delivery and the target information of a target object acquired by the autonomous sensor on a per-target basis (A2). The control unit 6 determines the quality of the map data for provisional delivery based on the collation result (A3).

When determined that the quality of the map data for provisional delivery is good (YES at A3), the control unit 6 causes the data communication unit 7 to transmit a determination result indicating the good quality of the map data for provisional delivery to the server 3 (A4) and ends the collation process for provisional delivery. Meanwhile, when determined that the quality of the map data for provisional delivery is poor (NO at A3), the control unit 6 causes the data communication unit 7 to transmit a determination result indicating the poor quality of the map data for provisional delivery to the server 3 (A5) and ends the collation process for provisional delivery.

An example is given above in which, under a premise that the server 3 simultaneously transmits the map data for provisional delivery and the inspection instruction, the control unit 6 determines the reception of the map data for provisional delivery and the inspection instruction transmitted from the server 3. However, the inspection instruction may be transmitted after a predetermined amount of time has elapsed from the server 3 transmitting the map data for provisional delivery. In this case, the control unit 6 determines the reception of the inspection instruction transmitted from the server 3 after determining the reception of the map data for provisional delivery transmitted from the server 3.

(1-2) Deliverability Determination Process for Provisional Delivery Performed by the Server 3

In the server 3, when a starting condition for a deliverability determination process for provisional delivery is established, the control unit 10 starts the deliverability determination process for provisional delivery and determines the reception of the determination result regarding the map data for provisional delivery transmitted from the onboard apparatus 2 (B1, corresponding to a determination result receiving step). When determined that the determination result regarding the map data for provisional delivery transmitted from the onboard apparatus 2 is not received (NO at B1), the control unit 10 ends the deliverability determination process for provisional delivery and waits for a subsequent establishment of the starting condition for the deliverability determination process for provisional delivery.

When determined that the determination result regarding the map data for provisional delivery transmitted from the onboard apparatus 2 is received by the data communication unit 11 (YES at B1), the control unit 10 performs a screening process (B2) and statistical processing (B3) of the received determination result regarding the map data for provisional delivery, and determines the deliverability of the map data (B4, corresponding to a validity determining step).

For example, when there are numerous determination results indicating the good quality of the map data for provisional delivery and the map data is determined to be deliverable (YES at B4), the control unit 10 starts formal delivery of the map data from the server 3 to the onboard apparatus 2 (B5, corresponding to an validity control step) and ends the deliverability determination process for provisional delivery. Meanwhile, for example, when there are numerous determination results indicating the poor quality of the map data for provisional delivery and the map data is determined to be not deliverable (NO at B4), the control unit 10 reconstructs the map data without starting the formal delivery of the map data from the server 3 to the onboard apparatus 2 (B6) and ends the deliverability determination process for provisional delivery.

(1-3) Collation Process for Actual Delivery Performed by the Onboard Apparatus 2

In the onboard apparatus 2, the control unit 6 determines the establishment of the starting condition for the collation process for actual delivery. As the starting condition for the collation process for actual delivery, for example, the control unit 6 determines whether confirmation of the quality of the map data for provisional delivery is completed in the server 3, whether confirmation of the quality of the map data for provisional delivery such as through comparison to a satellite image visually by a human being or by image recognition software is completed, or whether an update of highly accurate map data, such as map data generated by a high performance sensor for surveying, is performed.

For example, when determined that the confirmation of the quality of the map data for provisional delivery by the server 3 is completed, the confirmation of the quality of the map data for provisional delivery such as through comparison to a satellite image visually by a human or by image recognition software is completed, or an update of highly accurate map data, such as map data generated by a high performance sensor for surveying, is performed, the control unit 6 determines that the starting condition for the collation process for actual delivery is established and starts the collation process for actual delivery.

When the collation process for actual delivery is started, the control unit 6 determines reception of the map data for actual delivery and the inspection instruction transmitted from the server 3 (A11). When determined that the map data and the inspection instruction transmitted from the server 3 are not received (NO at A11), the control unit 6 ends the collation process for actual delivery and waits for a subsequent establishment of the starting condition for the collation process for actual delivery.

When determined that the map data for actual delivery and the inspection instruction transmitted from the server 3 are received by the data communication unit 7 (YES at A11), the control unit 6 collates the target information on a target object included in the received map data for actual delivery and the target information on a target object acquired by the autonomous sensor on a per-target basis (A12). The control unit 6 determines the quality of the map data for actual delivery based on the collation results (A3).

When determined that the quality of the map data for actual delivery is good (YES at A13), the control unit 6 causes the data communication unit 7 to transmit a determination result indicating that the quality of the map data for actual delivery is good to the server 3 (A14) and ends the collation process for actual delivery. Meanwhile, when determined that the quality of the map data for actual delivery is poor (NO at A13), the control unit 6 causes the data communication unit 7 to transmit the determination result indicating that the map data to for actual delivery is of poor quality to the server 3 (A15) and ends the collation process for actual delivery.

An example is given above in which, under a premise that the server 3 simultaneously transmits the map data for actual delivery and the inspection instruction, the control unit 6 determines the reception of the map data for actual delivery and the inspection instruction transmitted from the server 3. However, the inspection instruction may be transmitted after a predetermined amount of time has elapsed from the server 3 transmitting the map data for actual delivery. In this case, the control unit 6 determines the reception of the inspection instruction transmitted from the server 3 after determining the reception of the map data for actual delivery transmitted from the server 3.

In addition, the server 3 may transmit only the inspection instruction without transmitting the map data for actual delivery. In this case, when determined that the inspection instruction transmitted from the server 3 is received, the control unit 6 performs above-described step A12 and subsequent steps using the map data for provisional delivery already delivered from the server 3 to the onboard apparatus 2 as the map data for actual delivery.

(1-4) Deliverability Determination Process for Actual Delivery Performed by the Server 3

In the server 3, when a starting condition for a deliverability determination process for actual delivery is established, the control unit 10 starts the deliverability determination process for actual delivery and determines the reception of the determination result regarding the map data for actual delivery transmitted from the onboard apparatus 2 (B11, corresponding to the determination result receiving step).

When determined that the determination result regarding the map data for actual delivery transmitted from the onboard apparatus 2 is not received (NO at B11), the control unit 10 ends the deliverability determination process for actual delivery and waits for a subsequent establishment of the starting condition for the deliverability determination process for actual delivery.

When determined that the determination result regarding the map data for actual delivery transmitted from the onboard apparatus 2 is received by the data communication unit 11 (YES at B11), the control unit 10 performs a screening process (B12) and statistical processing (B13) of the received determination result regarding the map data for actual delivery, and determines the deliverability of the map data (B14, corresponding to the validity determining step).

For example, when there are numerous determination results indicating that the quality of the map data for actual delivery is good and the map data is determined to be deliverable (YES at B14), the control unit 10 continues the formal delivery of the map data from the server 3 to the onboard apparatus 2 (B15, corresponding to the validity control step) and ends the deliverability determination process for actual delivery.

Meanwhile, for example, when there are numerous determination results indicating that the map data for actual delivery is of poor quality and the map data is determined to be not deliverable (NO at B14), the control unit 10 terminates, rather than continues, the formal delivery of the map data from the server 3 to the onboard apparatus 2 (B16), causes the data communication unit 11 to transmit a map data not-usable notification to the onboard apparatus 2 (B17), reconstructs the map data (B18), and ends the deliverability determination process for actual delivery.

Here, an example of a configuration in the onboard apparatus 2 in which, after the quality of the map data is determined, the determination result is immediately transmitted to the server 3 is given. However, a timing at which the probe data is transmitted to the server 3 and a timing at which the determination result is transmitted to the server 3 may be synchronized.

That is, in the onboard apparatus 2, the determination results may be temporarily accumulated, and the accumulated determination results may thereby be transmitted to the server 3 with a predetermined amount of time elapsing or a traveling distance of the vehicle reaching a predetermined distance as the trigger. In addition, in the onboard apparatus 2, for example, at ignition-on, the determination results accumulated during a trip from the previous ignition-on to ignition-off may be transmitted to the server 3. Alternatively, at ignition-off, the determination results accumulated during a trip from the current ignition-on to ignition-off may be transmitted to the server 3.

As described above, the following working effects can be achieved according to the first embodiment.

In the onboard apparatus 2, the quality of the map data is determined based on the collation result of a collation between the target information of a target object included in the map data and the target information of a target object acquired by the autonomous sensor on a per-target basis. In the server 3, deliverability of the map data is determined based on the determination result regarding the quality of the map data. When the map data is determined to be deliverable, delivery of the map data from the server 3 to the onboard apparatus 2 is permitted. Unlike that in the past in which route information is collated, as a result of target objects such as features, lanes, roads, and tiles included in the map data being the target object, quality assurance of map data can be performed on a per-feature basis, a per-lane basis, a per-road basis, a per-tile basis, or the like. Quality assurance of the map data can be appropriately performed.

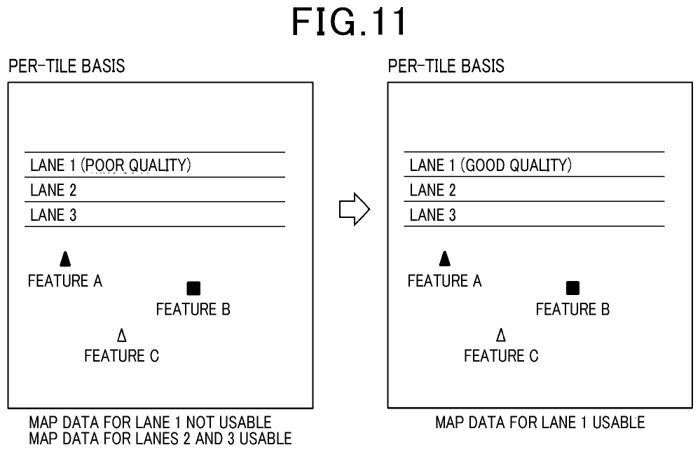

As shown in FIG. 11, for example, when the quality of map data of lane 1 in a three-lane road is determined to be poor, an area that is determined to have poor quality can be limited to lane 1 rather than an overall tile. Quality assurance of lanes 2 and 3 belonging to the same road as lane 1 can be continued. That is, for example, automated driving control and the like using the map data of lane 1 is not possible. However, automated driving control and the like using the map data of lanes 2 and 3 can be continued. If the quality of the map data of lane 1 subsequently is determined to be good, for example, automated driving control and the like using the map data of lane 1 becomes possible without waiting for the quality of the map data of the overall tile to be determined to be good. This similarly applies to per-feature basis. For example, when the quality of map data of a feature A is determined to be poor, the area that has poor quality can be limited to the feature A rather than the overall tile. Quality assurance of features B and C belonging to the same tile can be continued. Furthermore, in addition to per-lane basis and per-feature basis, this similarly applies to per-road basis. In this manner, effects of the area that is determined to have poor map data quality can be minimized and, when the quality of the map data is determined to be good, the map data of which the quality is determined to be good can be immediately used.

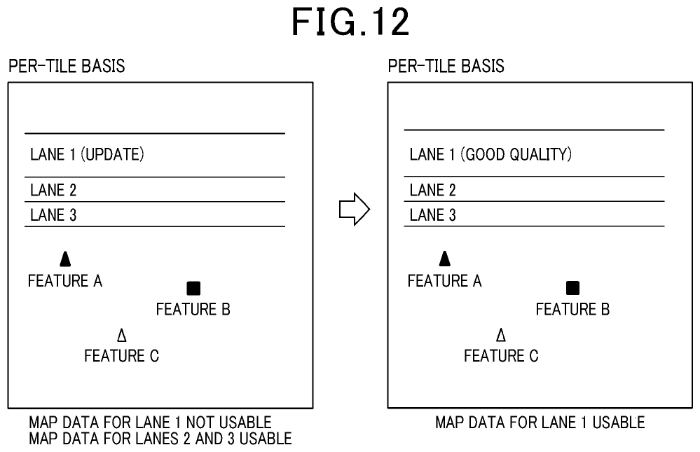

This similarly applies to when the map data is updated. As shown in FIG. 12, for example, when a lane width of lane 1 is expanded in a three-lane road, before the expansion of the lane width is reflected in the map data managed by the server 3, the lane information included in the map data managed by the server 3 and the lane information acquired by the autonomous sensor differ. The quality of the map data of lane 1 is determined to be poor. In this case as well, effects of the area that is determined to have poor map data quality can be minimized and, when the quality of the map data is determined to be good, the map data of which the quality is determined to be good can be immediately used. In addition, an area to be inspected can be limited to lane 1 rather than the overall tile. Quality assurance of lanes 2 and 3 belonging to the same road as lane 1 can be continued. This also similarly applies to per-feature basis and per-road basis.

In the onboard apparatus 2, the target information of a target object included in the map data and the target information of a target object acquired by the autonomous sensor mounted in the vehicle are collated. A plurality of unspecified processes for collating the target information can be prevented from being concentrated in the server 3 in advance. The plurality of unspecified processes for collating the target information can be dispersed among the onboard apparatuses 2.

Quality assurance of map data is performed with the map data for provisional delivery before formal delivery as a collation target object. As a result of the quality assurance of map data being performed before formal delivery, occurrence of malfunctions after formal delivery can be suppressed as much as possible.

Quality assurance of map data is performed with the map data for actual delivery after formal delivery as the collation target object. As a result of the quality assurance of map data being performed after formal delivery, malfunctions that occur after formal delivery can be promptly addressed.

In the onboard apparatus 2, in addition to the determination result regarding the quality of the map data, the information related to the determination target object, the information related to the calculation result calculated during the process of determination, the information related to vehicle control, and the information related to the surrounding environment are transmitted to the server 3.

When the quality of the map data is determined to be poor, through use of the information related to the determination target object, the information related to the calculation result calculated during the process of determination, the information related to vehicle control, and the information related to the surrounding environment, investigation of causes of the poor quality can be appropriately performed when the quality of the map data is determined to be poor.

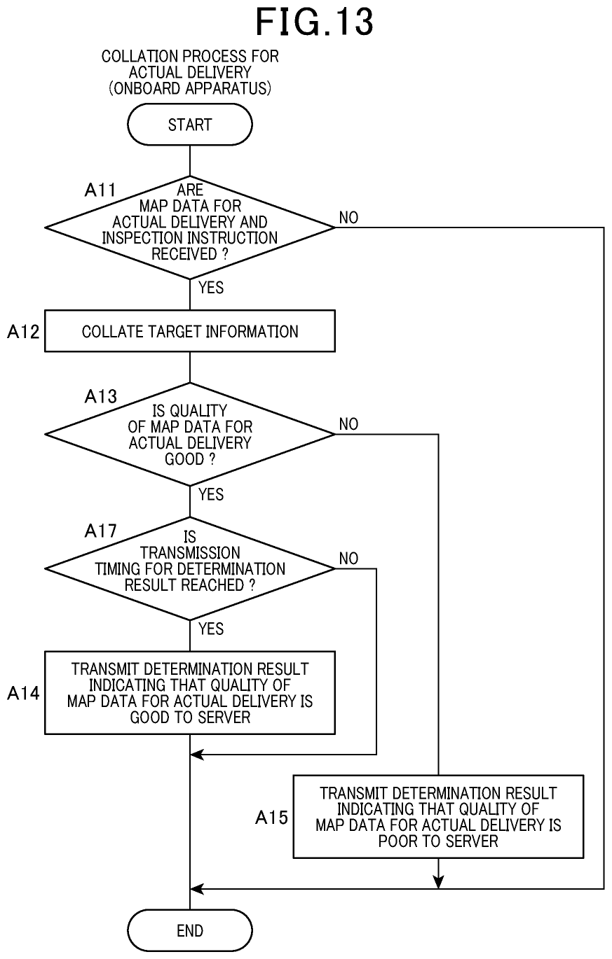

In the onboard apparatus 2, when the determination result that the quality of the map data for actual delivery is good is transmitted, whether a transmission timing for the determination result is reached may be determined. That is, as shown in FIG. 13, in the collation process for actual delivery, when determined that the quality of the map data for actual delivery is good (YES at A13), the control unit 6 determines whether a transmission timing for the determination result set in advance is reached (A17). For example, the transmission timing is set at a 100-millisecond cycle.

When determined that the transmission timing for the determination result is reached (YES at A17), the control unit 6 causes the data communication unit 7 transmit, to the server 3, the determination result indicating that the quality of the map data for actual delivery is good (A14), ends the deliverability determination process for actual delivery, and waits for a subsequent establishment of the starting condition for the deliverability determination process for actual delivery.

In this case, the control unit 6 may transmit the determination result indicating the good quality of the map data using a buffer function. That is, unless a data amount of the determination result has reached a predetermined amount at the transmission timing for the determination result, the control unit 6 may accumulate the determination results rather than transmitting from the data communication unit 7 to the server 3, and cause the data communication unit 7 to transmit the determination result from the server 3 under a condition that the data amount has reached the predetermined amount.

Meanwhile, when determined that the transmission timing for the determination result indicating the quality of the map data is not reached (NO at A17), the control unit 6 ends the deliverability determining process for actual delivery without making the data communication unit 7 transmit, to the server 3, the determination result indicating that the quality of the map data for actual delivery is good, and waits for a subsequent establishment of the starting condition for the deliverability determination process for actual delivery.

### Second Embodiment

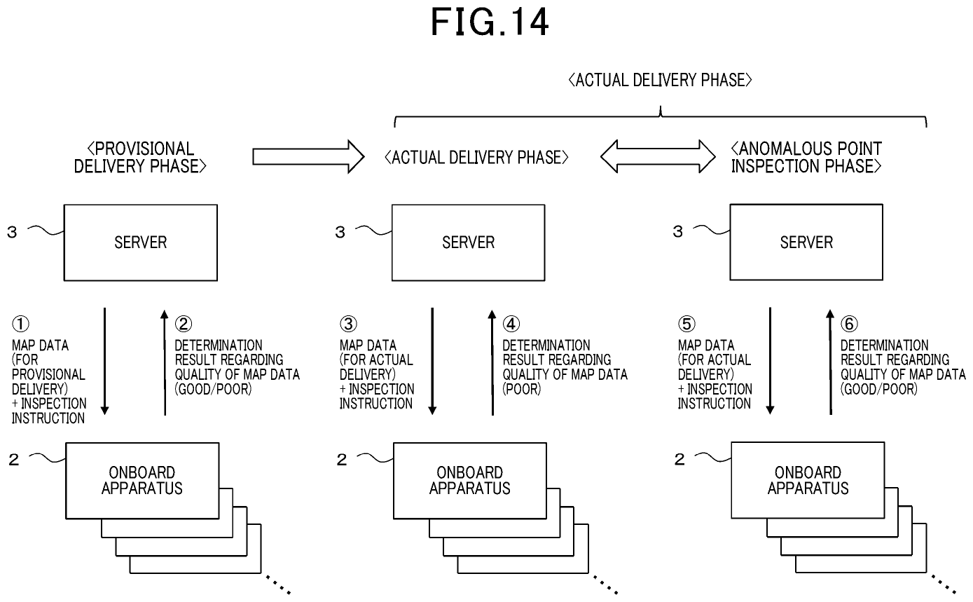

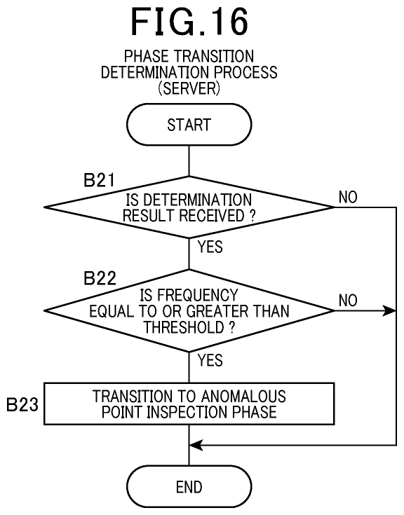

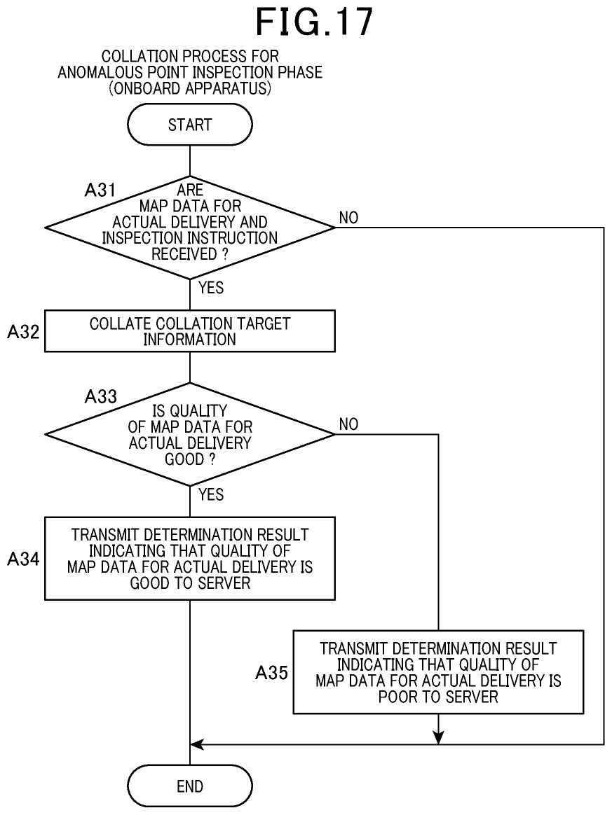

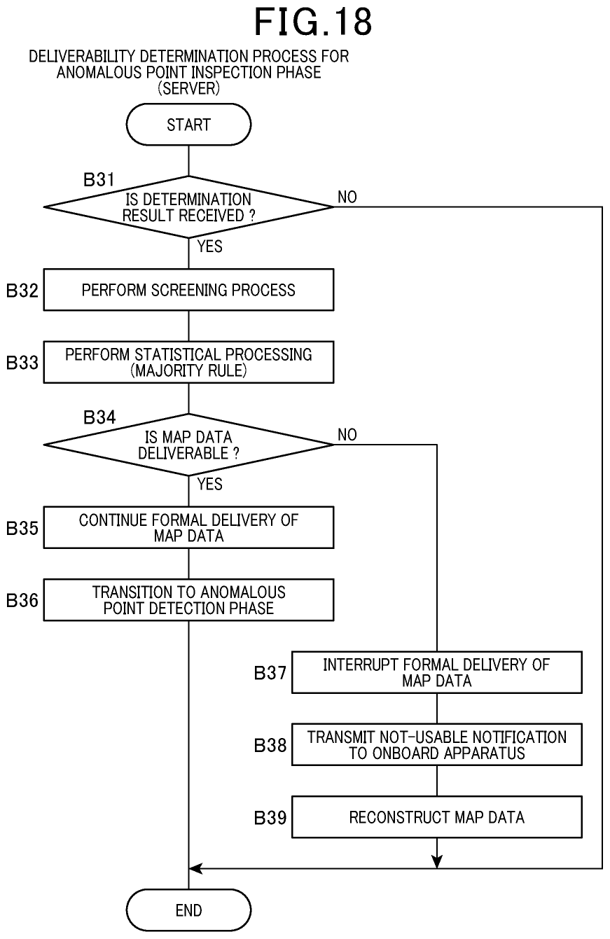

Next, a second embodiment will be described with reference to FIG. 14 to FIG. 18. An object according to the second embodiment is to suppress increase in a data communication amount from the onboard apparatus 2 to the server 3.

As shown in FIG. 14, as an aspect of delivery of map data from the onboard apparatus 2 to the server 3, transition from a provisional delivery phase to an actual delivery phase is similar to that according to the first embodiment. However, the actual delivery phase being divided into an anomalous point detection phase and an anomalous point inspection phase differs from that according to the first embodiment. The anomalous point detection phase is a phase that does not exist in the first embodiment. The anomalous point inspection phase is a phase that is equivalent to the actual delivery phase according to the first embodiment.

In the anomalous point detection phase, the server 3 transmits the map data for actual delivery and the inspection instruction to an plurality of unspecified onboard apparatuses 2. Upon receiving the map data for actual delivery and the inspection instruction transmitted from the server 3, the plurality of unspecified onboard apparatuses 2 collate the target information of a target object included in the received map data for actual delivery and the target information of a target object acquired by the autonomous sensor mounted in the vehicle on a per-target basis. After determining the quality of the map data for actual delivery, the plurality of unspecified onboard apparatuses 2 transmit, to the server 3, only the determination results for poor quality and does not transmit the determination results for good quality of the map data for actual delivery.

Upon receiving the determination results for poor quality of the map data for actual delivery transmitted from the plurality of unspecified onboard apparatuses 2, the server 3 performs statistical analysis of the received detection results and determines whether transition from the anomalous point detection phase to the anomalous point inspection phase is possible. When determined that transition from the anomalous point detection phase to the anomalous point inspection phase is possible, the server 3 transitions from the anomalous point detection phase to the anomalous point inspection phase.

In the anomalous point inspection phase, the server 3 transmits the map data for actual delivery and the inspection instruction to an plurality of unspecified onboard apparatuses 2. Upon receiving the map data for actual delivery and the inspection instruction transmitted from the server 3, the plurality of unspecified onboard apparatuses 2 collate the target information of a target object included in the received map data for actual delivery and the target information of a target object acquired by the autonomous sensor mounted in the vehicle on a per-target basis. After determining the quality of the map data for actual delivery, the plurality of unspecified onboard apparatuses 2 transmit, to the server 3, the determination results regarding the quality of the map data for actual delivery.

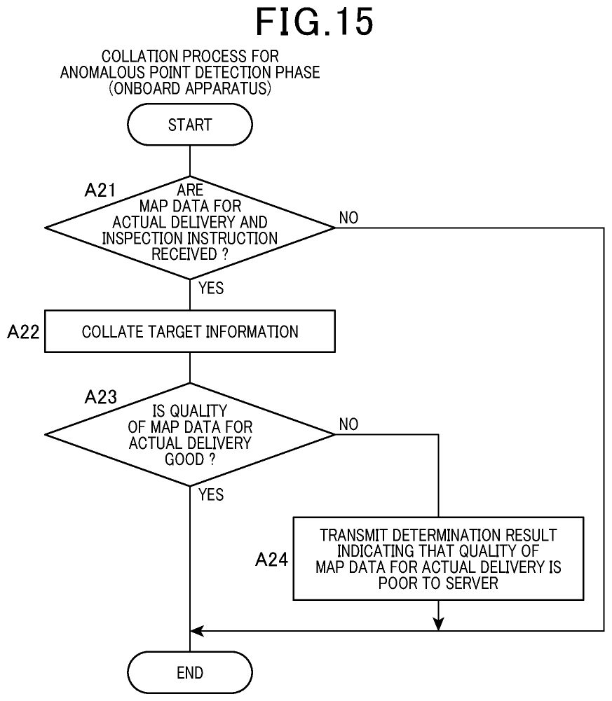

Next, workings of the configuration described above will be described with reference to FIG. 15 to FIG. 18. Processes performed by the onboard apparatus 2 and the server 3 in the anomalous point detection phase and the anomalous point inspection phase during actual delivery of map data will be successively described. In the anomalous point detection phase, the onboard apparatus 2 performs a collation process for the anomalous point detection phase and the server 3 performs a phase transition determination process. In the anomalous point inspection phase, the onboard apparatus 2 performs a collation process for the anomalous point inspection phase and the server 3 performs a deliverability determination process for the anomalous point inspection phase.

(2-1) Collation Process for the Anomalous Point Detection Phase Performed by the Onboard Apparatus 2

In the onboard apparatus 2, when determined that the map data for actual delivery and the inspection instruction transmitted from the server 3 are received by the data communication unit 7 (YES at A21), the control unit 6 collates the target information of the target object (A22) and determines the quality of the map data for actual delivery (A23).

When determined that the quality of the map data for actual delivery is good (YES at A23), the control unit 6 ends the collation process for the anomalous point detection phase without making the data communication unit 7 transmit, to the server 3, the determination result indicating that the quality of the map data for actual delivery is good.

Meanwhile, when determined that the quality of the map data of actual delivery is poor (NO at A23), the control unit 6 causes the data communication unit 7 to transmit, to the server 3, the determination result indicating that the map data for actual delivery is of poor quality (A24) and ends the collation process for the anomalous point detection phase.

(2-2) Phase Transition Determination Process Performed by the Server 3

In the server 3, when determined that the determination result regarding the map data for actual delivery transmitted from the onboard apparatus 2 is received by the data communication unit 11 (YES at B21), the control unit 10 determines whether a frequency of the determination result for poor quality is equal to or greater than a threshold (B22).

When determined that the frequency of the determination result for poor quality is not equal to or greater than the threshold (NO at B22), the control unit 10 ends the phase transition determination process without transitioning from the anomalous point detection phase to the anomalous point inspection phase.

Meanwhile, when determined that the frequency of the determination result for poor quality is equal to or greater than the threshold (YES at B22), the control unit 10 transitions from the anomalous point detection phase to the anomalous point inspection phase (B23) and ends the phase transition determination process.

(2-3) Collation Process for the Anomalous Point Inspection Phase Performed by the Onboard Apparatus 2

In the onboard apparatus 2, when determined that the map data for actual delivery and the inspection instruction transmitted from the server 3 are received by the data communication unit 7 (YES at A31), the control unit 6 collates the target information of the target object (A32) and determines the quality of the map data for actual delivery (A33). When determined that the quality of the map data for actual delivery is good (YES at A33), the control unit 6 causes the data communication unit 7 to transmit, to the server 3, the detection result indicating that the quality of the map data for actual delivery is good (A34) and ends the collation process for the anomalous point inspection phase.

Meanwhile, when determined that the quality of the map data for actual delivery is poor (NO at A33), the control unit 6 causes the data communication unit 7 to transmit, to the server 3, the detection result indicating that the map data for actual delivery is of poor quality (A35) and ends the collation process for the anomalous point inspection phase.

(2-4) Deliverability Determination Process for the Anomalous Point Inspection Phase Performed by the Server 3

In the server 3, when determined that the determination result regarding the map data for actual delivery transmitted from the onboard apparatus 2 is received by the data communication unit 11 (YES at B31), the control unit 10 performs a screening process (B32) and statistical processing (B33) of the received determination result regarding the map data for actual delivery, and determines the deliverability of the map data.

When determined that the map data is deliverable (YES at B34), the control unit 10 continues the formal delivery of the map data from the server 3 to the onboard apparatus 2 (B35), transitions from the anomalous point inspection phase to the anomalous point detection phase (B36), that is, returns to the anomalous point detection phase, and ends the deliverability determination process for the anomalous point inspection phase. Meanwhile, when determined that the map data is not deliverable (NO at B34), the control unit 10 causes the data communication unit 11 to transmit a map data not-usable notification to the onboard apparatus 2 (B38), reconstructs the map data (B39), and ends the deliverability determination process for the anomalous point inspection phase.

As described above, the following working effects can be achieved according to the second embodiment.

In the onboard apparatus 2, the actual delivery phase is divided into the anomalous point detection phase and the anomalous point inspection phase. In the anomalous point detection phase, the determination results for good quality of the map data are not transmitted to the server 3 and only the determination results for poor quality are transmitted to the server 3. As a result of the determination results for good quality of the map data not being transmitted to the server 3, increase in the data communication amount from the onboard apparatus 2 to the server 3 can be suppressed compared to when the determination results for good quality and the determination results for poor quality of the map data are both transmitted to the server 3.

In the server 3, transition from the anomalous point detection phase and the anomalous point inspection phase is performed when the frequency of the determination results for poor quality of the map data for actual delivery transmitted from the onboard apparatus 2 is equal to or greater than a threshold. As a result of transition to the anomalous point inspection phase, the determination results for good quality and the determination results for poor quality of the map data can both be acquired from the onboard apparatus 2, and a detailed investigation of the map data determined to have poor quality can be performed.

That is, in the onboard apparatus 2, after acquisition of the map data for actual delivery from the server 3, only the determination results for poor quality of the map data are transmitted to the server 3. The determination results for good quality and the determination results for poor quality of the map data are both transmitted to the server 3 only when the frequency of the determination results for poor quality of the map data is equal to or greater than a threshold. Consequently, a detailed investigation of the map data determined to have poor quality can be performed while increase in the data communication amount from the onboard apparatus 2 to the server 3 is suppressed.

### Third Embodiment

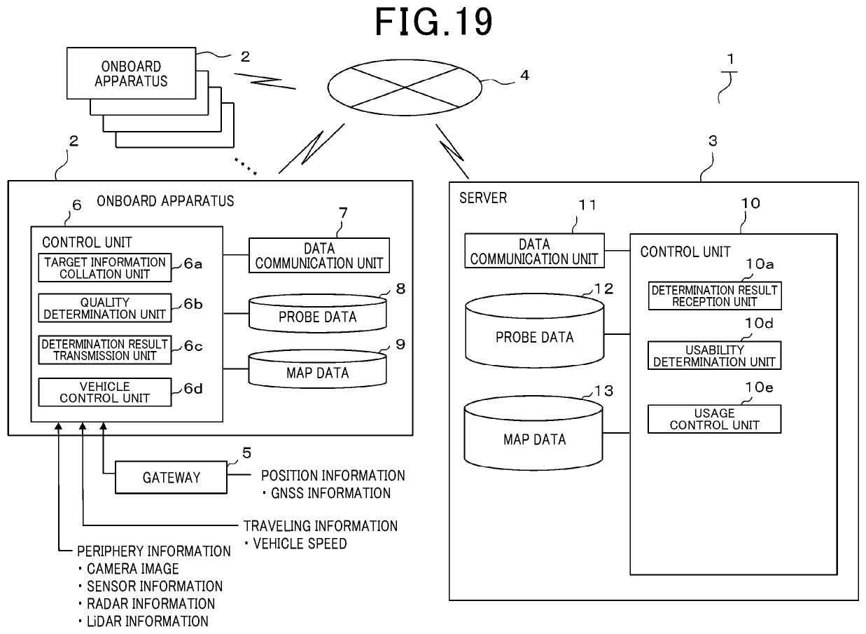

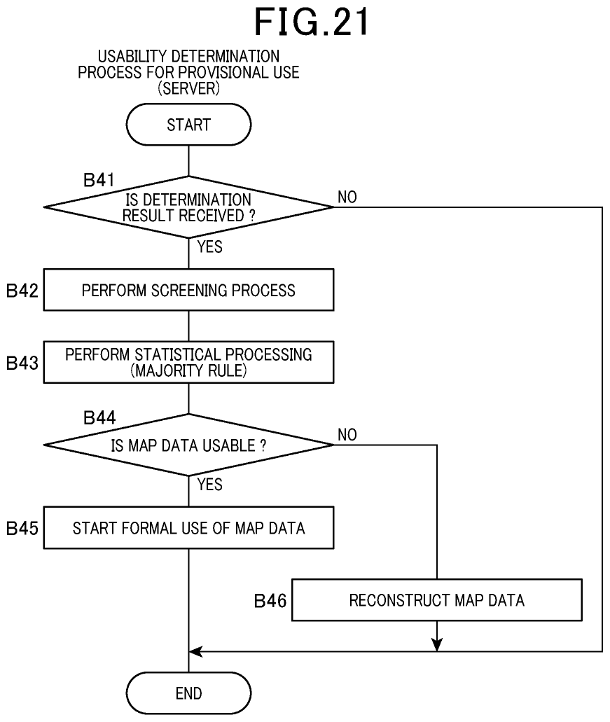

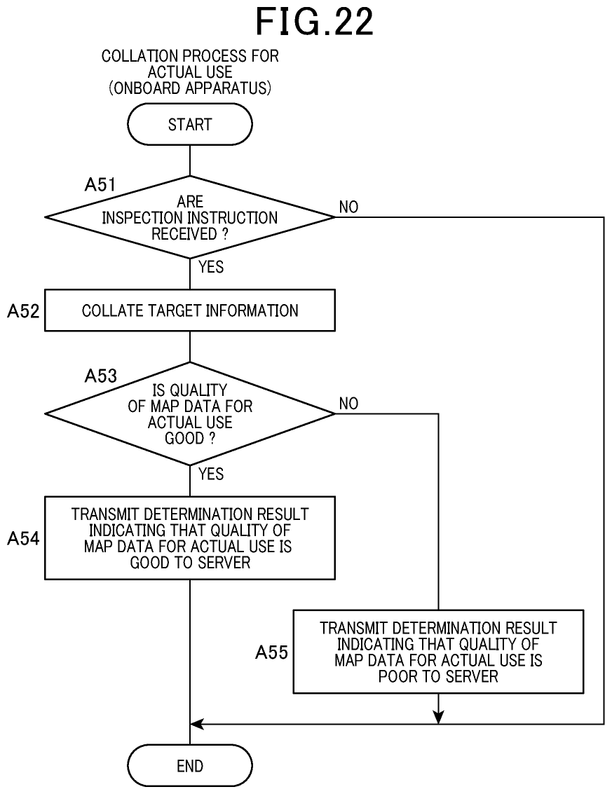

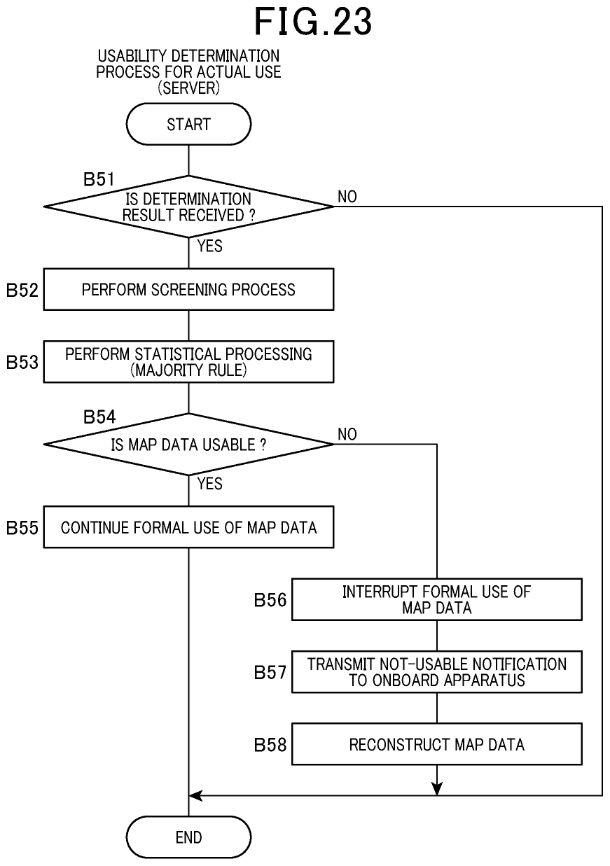

Next, a third embodiment will be described with reference to FIG. 19 to FIG. 23. According to the third embodiment, usability of map data already delivered from the server 3 to the onboard apparatus 2 is determined as validity of the map data.

In the server 3, the control unit 10 includes the determination result reception unit 10a, a usability determination unit 10d, and a usage control unit 10e. The usability determination unit 10d corresponds to the validity determination unit. The usage control unit 10e corresponds to the validity control unit. These units 10a, 10d, and 10e correspond to a portion of a function performed by a quality assurance program for map data. That is, the control unit 10 performs the functions of the units 10a, 10d, and 10e by running a portion of the quality assurance program for map data.

The usability determination unit 10d determines usability of map data based on the determination result regarding quality of the map data transmitted from the server 3. As a method for determining the usability of the map data, the usability determination unit 10d performs a screening process and statistical processing by majority rule in a manner similar to the deliverability determination unit 10b described according to the first embodiment.

During provisional use of map data, if the usability determination unit 10d determines that map data for provisional use is usable, the usage control unit 10e permits use of the map data already delivered from the server 3 to the onboard apparatus 2 and starts formal use of the map data already delivered from the server 3 to the onboard apparatus 2. That is, by starting formal use of the map data already delivered from the server 3 to the onboard apparatus 2, the usage control unit 10e provides vehicle control and the like using the map data.

In this case, for example, the usage control unit 10e causes the data communication unit 11 to transmit a usable command to the onboard apparatus 2. By receiving the usable command transmitted from the server 3, the onboard apparatus 2 is capable of performing vehicle control and the like using the map data already delivered from the server 3. Meanwhile, when the usability determination unit 10d determines that the map data for provisional use is not usable, the usage control unit 10e reconstructs the map data without starting formal use of the map data already delivered from the server 3 to the onboard apparatus 2.

During actual use of map data, if the usability determination unit 10b determines that map data for actual use is usable, the usage control unit 10e permits use of the map data already delivered from the server 3 to the onboard apparatus 2 and continues formal use of the map data already delivered from the server 3 to the onboard apparatus 2. That is, the usage control unit 10e continues providing vehicle control and the like using the map data by continuing formal use of the map data already delivered from the server 3 to the onboard apparatus 2.

In this case as well, for example, the usage control unit 10e causes the data control unit 11 to transmit the usable command to the onboard apparatus 2. By receiving the usable command transmitted from the server 3, the onboard apparatus 2 is capable of continuing execution of vehicle control and the like using the map data already delivered from the server 3. Meanwhile, when the usability determination unit 10d determines that the map data for actual use is not usable, the usage control unit 10e interrupts, rather than continues, the formal use of the map data already delivered from the server 3 to the onboard apparatus 2, causes the data communication unit 11 to transmit a map data not-usable notification to the onboard apparatus 2, and reconstructs the map data.

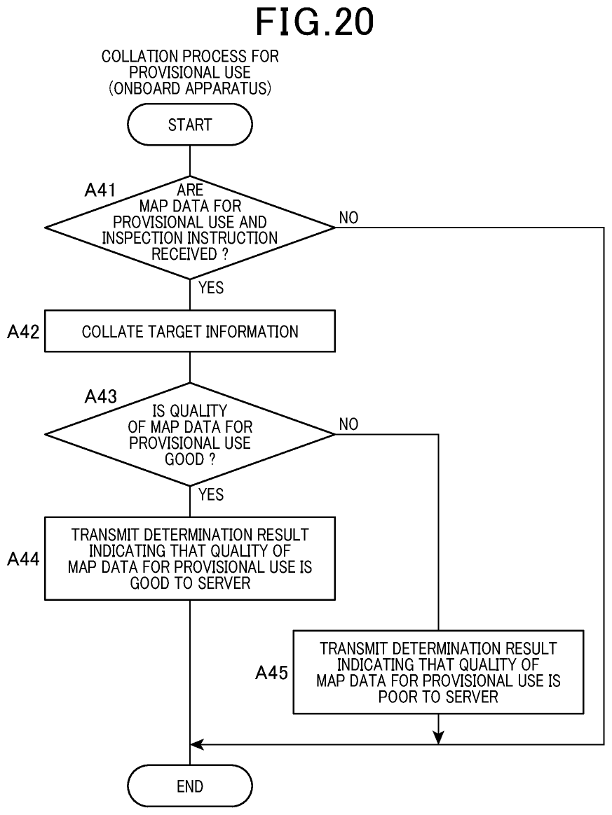

Next, workings of the configuration described above will be described with reference to FIG. 20 to FIG. 23. During provisional use of the map data, the onboard apparatus 2 performs a collation process for provisional use and the server 3 performs a usability determination process for provisional use. During actual use of the map data, the onboard apparatus 2 performs a collation process for actual use and the server 3 performs a usability determination process for actual use.

(3-1) Collation Process for Provisional Use Performed by the Onboard Apparatus 2

In the onboard apparatus 2, when determined that a starting condition for the collation process for provisional use is established, the control unit 6 starts the collation process for provisional use and determines reception of the map data for provisional use and an inspection instruction transmitted from the server 3 (A41). The starting condition for the collation process for provisional use may be identical to the starting condition for the collation process for provisional delivery described according to the first embodiment. When determined that the map data for provisional use and the inspection instruction transmitted from the server 3 are not received (NO at A41), the control unit 6 ends the collation process for provisional use.

When determined that the map data for provisional use and the inspection instruction transmitted from the server 3 are received (YES at A41), the control unit 6 collates the target information of a target object included in the received map data for provisional use and the target information of a target object acquired by the autonomous sensor on a per-target basis (A42). The control unit 6 determines the quality of the map data for provisional use based on the collation result (A43).

When determined that the quality of the map data for provisional use is good (YES at A43), the control unit 6 causes the data communication unit 7 to transmit, to the server 3, the determination result indicating the good quality of the map data for provisional use (A44) and ends the collation process for provisional use. Meanwhile, when determined that the quality of the map data for provisional use is poor (NO at A43), the control unit 6 causes the data communication unit 7 to transmit, to the server 3, the determination result indicating the poor quality of the map data for provisional use (A45), and ends the collation process for provisional use.

In this case as well, an example is given above in which, under a premise that the server 3 simultaneously transmits the map data for provisional use and the inspection instruction, the control unit 6 determines the reception of the map data for provisional use and the inspection instruction transmitted from the server 3. However, the inspection instruction may be transmitted after a predetermined amount of time has elapsed from the server 3 transmitting the map data for provisional use. In this case, the control unit 6 determines the reception of the inspection instruction transmitted from the server 3 after determining the reception of the map data for provisional use transmitted from the server 3.

(3-2) Usability Determination Process for Provisional Use Performed by the Server 3

In the server 3, when a starting condition for a deliverability determination process for provisional use is established, the control unit 10 starts the deliverability determination process for provisional use and determines the reception of the determination result regarding the map data for provisional use transmitted from the onboard apparatus 2 (B41, corresponding to the determination result receiving step).

When determined that the determination result regarding the map data for provisional use transmitted from the onboard apparatus 2 is received by the data communication unit 11 (YES at B41), the control unit 10 performs a screening process (B42) and statistical processing (B43) of the received determination result regarding the map data for provisional use, and determines the usability of the map data (B44, corresponding to the validity determining step).

For example, when there are numerous determination results indicating the good quality of the map data for provisional use and the map data is determined to be usable (YES at B44), the control unit 10 causes the data communication unit 11 to transmit the usable command to the onboard apparatus 3 and starts formal use of the map data already delivered from the server 3 to the onboard apparatus 2 (B45, corresponding to the validity control step), and ends the usability determination process for provisional use.

Meanwhile, for example, when there are numerous determination results indicating the poor quality of the map data for provisional use and the map data is determined to be not usable (NO at B44), the control unit 10 does not cause the data communication unit 11 to transmit the usable command to the onboard apparatus 2, reconstructs the map data without starting the formal delivery of the map data from the server 3 to the onboard apparatus 2 (B6), and ends the usability determination process for provisional use.

(3-3) Collation Process for Actual Use Performed by the Onboard Apparatus 2

In the onboard apparatus 2, when determined that a starting condition for a collation process for actual use is established, the control unit 6 starts the collation process for actual use and determines the reception of the inspection instruction transmitted from the server 3 (A41). The starting condition for the collation process for actual use may be identical to the starting condition for the collation process for actual delivery described according to the first embodiment. When determined that the inspection instruction transmitted from the server 3 is not received (NO at A51), the control unit 6 ends the collation process for actual use.

When determined that the inspection instruction transmitted from the server 3 is received by the data communication unit 7 (YES at A51), the control unit 6 uses the map data for provisional usability already delivered from the server 3 to the onboard apparatus 2 as the map data for actual usability, and collates the target information of a target object included in the map data for actual use and the target information of a target object acquired by the autonomous sensor on a per-target basis (A52). The control unit 6 determines the quality of the map data for actual use based on the collation result (A53).

When determined that the quality of the map data for actual use is good (YES at A53), the control unit 6 causes the data communication unit 7 to transmit, to the server 3, the determination result indicating the good quality of the map data for actual use (A54) and ends the collation process for actual use. Meanwhile, when determined that the quality of the map data for actual use is poor (NO at A53), the control unit 6 causes the data communication unit 7 to transmit, to the server 3, the determination result indicating the poor quality of the map data for actual use (A55) and ends the collation process for actual use.

In the server 3, when the starting condition for the usability determination process for actual use is established, the control unit 10 starts the usability determination process for actual use and determines reception of the determination result regarding the map data for actual use transmitted from the onboard apparatus 2 (B51, corresponding to the determination result receiving step). When determined that the determination result regarding the map data for actual use transmitted from the onboard apparatus 2 is received by the data communication unit 11 (YES at B51), the control unit 10 performs a screening process (B52) and statistical processing (B53) of the received determination result regarding the map data for actual use, and determines usability of the map data (B54, corresponding to the validity determining step).

For example, when there are numerous determination results indicating the good quality of the map data for actual use and the map data is determined to be usable (YES at B54), the control unit 10 causes the data communication unit 11 to transmit the usable command to the onboard apparatus 2, continues the formal use of the map data already determined from the server 3 to the onboard apparatus 2 (B55, corresponding to the validity control step), and ends the usability determination process for actual use).

Meanwhile, for example, when there are numerous determination results indicating the poor quality of the map data for actual use and the map data is determined to be not usable (NO at B54), the control unit 10 causes the data communication unit 11 to transmit a not-usable command to the onboard apparatus 2, interrupts rather than continues the formal use of the map data from the server 3 to the onboard apparatus 2 (B56), causes the data communication unit 11 to transmit a map data not-usable notification to the onboard apparatus 2 (B57), reconstructs the map data (B58), and ends the usability determination process for actual use.

As described above, the following working effects can be achieved according to the third embodiment.

In the onboard apparatus 2, the quality of the map data is determined based on a collation result between the target information of a target object included in the map data and the target information of a target object acquired by the autonomous sensor mounted in the vehicle.

In the server 3, usability of the map data is determined based on the determination result regarding the quality of the map data, and use of the map data already delivered from the server 3 to the onboard apparatus 2 is permitted when the map data is determined to be usable. In this case as well, as a result of target objects such as features, lanes, roads, and tiles included in the map data being set as target objects, quality assurance of map data can be performed on a per-feature basis, a per-lane basis, a per-road basis, a per-tile basis, and the like. Quality assurance of map data can be appropriately performed.

### OTHER EMBODIMENTS

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

A configuration in which the onboard apparatus 2 collates the feature information is given as an example. However, a plurality of servers may be provided separately from the server 3, and a plurality of unspecified processes for collating the feature information may be dispersed among the plurality of servers. That is, in the onboard apparatus 2, the target information of a target object acquired by the autonomous sensor may be transmitted to the server, and in the server 3, the target information received from the onboard apparatus 2 and the target information of a target object included in the map data may be collated without the map data being transmitted to the onboard apparatus 2.

The first embodiment and the third embodiment may be combined. As the determination of the validity of the map data, the determination of deliverability of the map data described according to the first embodiment and the determination of usability of the map data described according to the third embodiment may both be used in combination. The method described according to the second embodiment in which the actual delivery phase is divided into the anomalous point detection phase and the anomalous point inspection phase may be applied to the third embodiment.

The control unit and the method thereof described in the present disclosure may be implemented by a dedicated computer that is provided to be configured by a processor and a memory, the processor being programmed to provide one or a plurality of functions that are realized by a computer program. Alternatively, the control unit and the method thereof described in the present disclosure may be implemented by a dedicated computer that is provided by a processor being configured by a single dedicated hardware logic circuit or more. Still alternatively, the control unit and the method thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory computer-readable (tangible) storage medium that can be read by a computer as instructions performed by the computer.

What is claimed is:

1. A map data delivery system in which map data is delivered from a map data delivery apparatus to an onboard apparatus, the map data delivery system comprising:
a target information collation unit that collates target information of a target object included in the map data and target information of a target object acquired by an autonomous sensor mounted in a vehicle on a per-target basis;
a quality determination unit that determines quality of the map data based on the collation result regarding the target information;
a determination result transmission unit that transmits a determination result regarding the quality of the map data to the map data delivery apparatus;
a validity determination unit that determines validity of the map data based on the determination result regarding the quality of the map data; and
a validity control unit that permits validity of the map data in response to the map data being determined to be valid, wherein
the determination result transmission unit does not transmit the determination results for good quality of the map data to the map data delivery apparatus and transmits only the determination results for poor quality to the map data delivery apparatus until a predetermined condition is determined to be established, and transmits the determination result regarding the quality of the map data to the map data delivery apparatus after the predetermined condition is determined to be established.

2. The map data delivery system according to claim 1, wherein:
the determination result transmission unit determines that the predetermined condition is established in response to the map data delivery apparatus identifying that a frequency of the determination results for the poor quality of the map data is equal to or greater than a threshold.

3. The map data delivery system according to claim 2, wherein:
the target information collation unit collates, with map data for provisional validity before formal validity as a collation target object, the target information of a target object included in the map data for provisional validity and target information of a target object acquired by the autonomous sensor on a per-target basis, and
the validity control unit permits start of formal validity of the map data in response to the map data for provisional validity being determined to be valid.

4. The map data delivery system according to claim 3, wherein:
the validity control unit suppresses the start of formal validity of the map data in response to the map data being determined to be not valid.

5. The map data delivery system according to claim 4, wherein:
the target information collation unit collates, with map data for actual validity after formal validity as a collation target object, the target information of a target object included in the map data for actual validity and the target information of a target object acquired by the autonomous sensor on a per-target basis; and
the validity control unit permits continuation of formal validity of the map data in response to the map data for actual validity being determined to be valid.

6. The map data delivery system according to claim 5, wherein:
the validity control unit suppresses continuation of formal validity of the map data in response to the map data being determined to be not valid.

7. The map data delivery system according to claim 6, wherein:
the validity determination unit determines, as the validity of the map data, deliverability of the map data from the map data delivery apparatus to the onboard apparatus; and
the validity control unit permits delivery of the map data from the map data delivery apparatus to the onboard apparatus in response to the map data being determined to be deliverable.

8. The map data delivery system according to claim 6, wherein:
the validity determination unit determines, as the validity of the map data, usability of map data already delivered from the map data delivery apparatus to the onboard apparatus; and
the validity control unit permits use of the map data already delivered from the map data delivery apparatus to the onboard apparatus in response to the map data being determined to be usable.

9. The map data delivery system according to claim 8, wherein:
the map data delivery apparatus includes a determination result reception unit that receives the determination result regarding the quality of the map data, the validity determination unit, and the validity control unit.

10. The map data delivery system according to claim 1, wherein:
the determination result transmission unit transmits, to the map data delivery apparatus, at least any one of information related to a determination target information related to a calculation result calculated during a process of determination, information related to vehicle control, and information related to surrounding environment, in addition to the determination result regarding the quality of the map data.

11. The map data delivery system according to claim 1, wherein:
the determination result transmission unit transmits, to the map data delivery apparatus, information on quality on a per-target basis, in addition to the determination result regarding the quality of the map data.

12. The map data delivery system according to claim 11, wherein:
the onboard apparatus includes a vehicle control unit that performs vehicle control based on a collation result for each attribute related to the target object.

13. The map data delivery system according to claim 12, wherein:
the target information collation unit collates at least any of feature information on a feature, lane information on a lane, road information on a road, and tile information on a tile as the target information of a target object, on a per-target basis; and
the quality determination unit determines the quality of the map data on at least any of a per-feature basis, a per-lane basis, a per-road basis, and a per-tile basis.

14. The map data delivery system according to claim 1, wherein:
the target information collation unit collates, with map data for provisional validity before formal validity as a collation target object, the target information of a target object included in the map data for provisional validity and target information of a target object acquired by the autonomous sensor on a per-target basis, and
the validity control unit permits start of formal validity of the map data in response to the map data for provisional validity being determined to be valid.

15. The map data delivery system according to claim 1, wherein:
the target information collation unit collates, with map data for actual validity after formal validity as a collation target object, the target information of a target object included in the map data for actual validity and the target information of a target object acquired by the autonomous sensor on a per-target basis; and
the validity control unit permits continuation of formal validity of the map data in response to the map data for actual validity being determined to be valid.

16. The map data delivery system according to claim 1, wherein:
the validity determination unit determines, as the validity of the map data, deliverability of the map data from the map data delivery apparatus to the onboard apparatus; and
the validity control unit permits delivery of the map data from the map data delivery apparatus to the onboard apparatus in response to the map data being determined to be deliverable.

17. The map data delivery system according to claim 1, wherein:
the validity determination unit determines, as the validity of the map data, usability of map data already delivered from the map data delivery apparatus to the onboard apparatus; and
the validity control unit permits use of the map data already delivered from the map data delivery apparatus to the onboard apparatus in response to the map data being determined to be usable.

18. The map data delivery system according to claim 1, wherein:
the map data delivery apparatus includes a determination result reception unit that receives the determination result regarding the quality of the map data, the validity determination unit, and the validity control unit.

19. The map data delivery system according to claim 1, wherein:
the onboard apparatus includes a vehicle control unit that performs vehicle control based on a collation result for each attribute related to the target object.

20. The map data delivery system according to claim 1, wherein:
the target information collation unit collates at least any of feature information on a feature, lane information on a lane, road information on a road, and tile information on a tile as the target information of a target object, on a per-target basis; and
the quality determination unit determines the quality of the map data on at least any of a per-feature basis, a per-lane basis, a per-road basis, and a per-tile basis.
